(19) United States
(12) Patent Application Publication
(10) Pub. No.: US 2012/0239438 A1
(43) Pub. Date: Sep. 20, 2012

(54) SYSTEM AND METHOD FOR PROVIDING IMMEDIATE, SHORT-TERM LIFE INSURANCE COVERAGE AND FACILITATING OFFERS OF LONGER-TERM INSURANCE

(75) Inventors: Richard A. Hemmings, Glenview, IL (US); James Harkensee, Arlington Heights, IL (US); Michael Rowell, Medina, WA (US)

(73) Assignee: FIDELITY LIFE ASSOCIATION, Rolling Meadows, IL (US)

(21) Appl. No.: 13/422,094

(22) Filed: Mar. 16, 2012

Related U.S. Application Data
(60) Provisional application No. 61/454,222, filed on Mar. 18, 2011.

(51) Int. Cl. G06Q 40/08

(52) U.S. Cl. 705/4

(57) ABSTRACT

The computerized system disclosed herein implements an improved online marketplace for facilitating sales of insurance products from a plurality of insurance providers to customers of insurance. The system enables the customers to apply for insurance products from each of the carriers in a single step using a single, common application. Thereafter, the system performs an immediate, preliminary underwriting, and if appropriate offers the individual the option for immediate short-term coverage. The system then performs more comprehensive underwriting on behalf of a plurality of carriers, and if the underwriting is successful, provides the customer with an offer for long-term coverage to replace the short-term coverage. The customer can accept any provided offer to receive coverage. The system also enables carriers to define filters so that if customers enter the system with an affiliation with a particular character, they remain affiliated with the carrier until the filter is no longer satisfied.

### PRIORITY CLAIM

This application is a non-provisional application of, claims priority to and the benefit of U.S. Provisional Patent Application No. 61/454,222, filed Mar. 18, 2011, the entire contents of which are incorporated herein by reference.

### COPYRIGHT NOTICE

A portion of the disclosure of this patent document contains material that is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### TECHNICAL FIELD

The present disclosure relates in general to computer system that enables users to apply to purchase insurance products having designated characteristics from a plurality of different potential providers of those insurance products. More specifically, the present disclosure relates to a system for enabling a plurality of users to submit a single application to purchase a life insurance product in a life insurance marketplace, and for providing the information from the single application and a set of medical evidence and at least an underwriting or risk assessment to a plurality of potential providers of the life insurance product, such that one or more potential providers can make offers to sell the life insurance product to one or more of the plurality of users.

### BACKGROUND

Individuals wishing to purchase insurance products, such as life insurance products, using known purchase mechanisms (e.g., known online purchase tools and/or contacting insurance sales agents) are faced with a number of problems during the process of applying for and purchasing life insurance. Frequently, a person wishing to purchase life insurances has a number of desires, including (1) the desire to receive immediate indications of the types of insurance he or she can purchase and the insurance companies from whom he or she can purchase insurance without those indications being insurance agent guesses, (2) the ability to easily compare the actually-available life insurance options presented by a number of potential life insurance company providers, and (3) the desire to receive insurance coverage shortly after selecting the insurance carrier from whom to purchase coverage. Known computerized systems do not satisfy these desires, and are thus deficient from the perspective of the potential purchaser of insurance. Known computerized systems are also deficient from the perspective of insurance providers at least because they do not enable insurance providers to participate in an efficient marketplace of purchasers of insurance, and do not enable potential purchasers who contact one provider directly to be inserted into the market including other providers as a whole if the contacted insurer does not satisfy the purchaser's desires.

As noted above, conventional insurance purchase methods do not address the desire of insurance purchasers to receive immediate indications of the types of insurance available for purchase, and the companies from whom such insurance is available. Instead, the present process for purchasing life insurance typically begins with an insurance agent (or a website) providing a guess as to the types of coverage available. To determine what coverage is actually available to a particular individual, the individual must undergo a complex application process that is separate (and frequently very different) for each of a plurality of potential insurance providers. Only after these applications have been processed can the individual see a true list of the insurance coverage options available to him or her. In other words, if an individual wishes to see insurance coverage actually available to him or her from five different insurance companies, the individual frequently must submit five separate applications to each individual company, and await the processing of each application by each insurance company. In some instances insurance companies or insurance agencies may claim to be able to compare insurance options. However, without proceeding to the point of an insurance company reviewing the prospective insureds' profile and underwriting the risk for insurance against their criteria, the “comparisons” offered by these agents are nothing more than an estimate that often turns out to be inaccurate.

As will be understood, in known insurance purchasing arrangements, the potential purchaser of insurance must be aware of the providers of insurance before submitting applications for insurance. This is undesirable because individuals purchasing insurance typically wish to rapidly see information indicating their options, and may not wish to specify the insurers from whom they are interested in purchasing insurance. Moreover, individuals who cannot quickly see the insurance available to them may lose interest or fail to complete the process of purchasing insurance.

Known insurance purchase mechanisms also do not enable a purchaser of insurance to quickly and easily compare the universe of insurance options available to the specific purchaser. Instead, as noted above, known systems require an individual to submit different, individual applications to each insurance provider the individual is considering, with each application conforming to the individual insurance provider's application requirements. In the example above, once the appropriate information is submitted to each of the five insurance providers, the five different providers may have different risk analysis processes and may take differing amounts of time to determine which (if any) insurance products to offer to the individual for purchase.

In such known systems, therefore, an individual wishing to compare the insurance offerings of multiple insurance providers against one another must engage in a time consuming, difficult, and complex process of individually submitting applications to each provider. Moreover, the individual must manually compile the results of the applications, including the insurance products that the various providers would be willing to sell to the individual, to fully understand the different options available. The difficulty of comparing different insurance products to one another is unacceptable to many buyers of insurance products.

Another undesirable aspect of conventional systems that enable the purchase of insurance coverage is that conventional systems do not enable an insured individual to receive coverage shortly after selecting a desired insurer. Since many purchasers of insurance desire coverage as near as possible to point in time at which an agreement to provide coverage is reached, conventional systems do not satisfy many potential purchasers of insurance.

In known systems, even upon providing personal information used to underwrite the risk associated with insuring an individual and/or submitting to a medical examination, insurance coverage is not typically provided immediately upon purchase other than through temporary or conditional coverage that provide limited or contingent coverage. For example, an individual may contact an insurance provider and provide personal information about him or herself, but may not receive life insurance coverage immediately upon communicating with the insurance provider. In some cases, the amount of time that can pass between initial contact with the insurer and provision of insurance coverage can be weeks or months. The most competitive prices for coverage are typically not available in the absence of medical underwriting, which can take weeks or months to complete. Thus, even in the event some conditional or limited coverage can be provided, it is typically not competitively priced.

This delay can result from an insurance provider wishing to adequately analyze the risk associated with a potential insured individual prior to providing insurance coverage. For example, an insurance provider may wish to obtain publicly available information about the individual and/or may wish for the individual to undergo a medical examination such that an insurance risk can be fully assessed and underwritten. Moreover, if an insurer provides an insurance policy for a relatively long period of time, the risk to the insurer can increase, as the insured individual may experience deteriorating health over that long period of time.

Insurance providers, such as life insurance providers, do not presently have a standardized process for how they evaluate risk. Therefore, if a potential insured individual (i.e., a consumer) wishes to shop for insurance from multiple insurance providers, that consumer must follow each provider's application and risk analysis processes. For example, a consumer may need to complete a number of medical examinations, provide health, driving record, and medical information a number of different times, and fill out a number of different applications for insurance. This non-standardized process is both cumbersome and inefficient, and frequently results in risk assessment procedures being performed well after the potentially insured individual has completed his or her tasks with regard to applying for insurance coverage. Thus, in known systems, it is frequently impossible to provide insurance coverage shortly after the completion of the application process.

Finally, known insurance purchase systems do not provide a marketplace for purchasers of insurance to efficiently connect with appropriate sellers of relevant insurance products. That is, in known systems, no functionality exists that enables purchasers to freely explore insurance options available from a plurality of different insurance providers in an efficient manner. Moreover, known systems do not provide insurance providers to which an application has been submitted with an option, at various points during the process of an individual purchasing insurance from a particular provider, to specify conditions that cause the purchaser to be inserted into the marketplace system by the provider and to have the opportunity to purchase insurance from other insurance providers. Thus, known computerized insurance purchase systems do not enable purchasers who contact a provider directly, but for whom the provider cannot (or does not wish to) provide coverage, to be matched with other providers participating in the computerized system. In other words, known systems do not facilitate affiliations between purchasers of insurance and insurance providers.

Accordingly, there is a need for a computerized system and method for facilitating the easy application and timely provision of insurance products to individuals wishing to purchase insurance. There is a further need for a computerized system in which individuals can submit a single application for insurance for consideration by a plurality of insurance providers in an insurance marketplace. This provision of information facilitates flexibility by multiple insurance companies in making offers of longer-term coverage in response to the application, such as by enabling the insurance companies to make an offer at a particular rate class of price. There is a need for a system that facilitates immediate provision of relatively short-term insurance coverage to individuals upon the individuals making contact with an insurer, and for thereafter providing fully underwritten coverage based on a uniform application constructed by the system. In such a system, individuals are provided with immediate coverage, as is desired during the insurance purchase process. Finally, there is a need for a system that facilitates an efficient marketplace, such that the system can funnel leads that are brought to the system by an insurance provider that cannot provide the desired coverage to a different insurance provider that can provide the desired coverage.

### SUMMARY

Various embodiments of the system disclosed herein address the shortcomings of known insurance sales systems described above. Embodiments of the system disclosed herein enable an individual to apply for insurance from a plurality of different potential insurers by completing a single application predetermined to be acceptable to each insurer. In one embodiment, upon completing the single application, the disclosed system displays a plurality of different types of insurance available to the individual. In this embodiment, each of the displayed types of insurance available to the individual constitute offers for insurance from a plurality of insurance providers, any of which can be accepted by the individual. For example, in one embodiment the system enables a plurality of insurers to provide offers of insurance coverage, including suggesting policy amounts and/or rate class preferences, in response to the single application. In one embodiment, this feature advantageously enables the individual to quickly and easily compare options of the various kinds of coverage actually available to him or her, as opposed to relying on estimates of an insurance agent or a computerized system.

In various embodiments, the disclosed system also enables the plurality of insurers to immediately underwrite the risk associated with providing insurance to the individual, such as by providing information about the individual (including subsequently obtained medical information) to the plurality of insurers at the time of application for insurance. In one such embodiment, the cost of underwriting is minimized because the disclosed system performs the underwriting only one time for the plurality of insurers. Based on the ease of providing information to the insurers, the system in various embodiments enables a purchaser of insurance to receive immediate coverage based on the immediately underwritten risk, at the time of applying for insurance and selecting a provider, rather than having to wait for many days or weeks as is often the case in known systems. Finally, in various embodiments, the disclosed system advantageously enables users who contact a particular insurance provider directly to be inserted into the marketplace as a whole if the originally contacted insurer cannot provide the insurance products the individual wishes to purchase.

One embodiment of the insurance marketplace system disclosed herein is a computerized insurance marketplace including at least one server device and a plurality of client devices. In this embodiment, the server device maintains data associated with a plurality of insurance providers and insurance seekers. In this embodiment, the server device also implements a plurality of different workflows, depending on the desired activity of either an applicant for insurance or a provider of insurance. Based on these workflows, the disclosed system enables individuals wishing to purchase insurance coverage to be matched to providers of insurance willing to provide the desired coverage. Two example workflows are described briefly below.

In a first workflow embodiment, which is described from the perspective of a potential purchaser of insurance coverage, the potential purchaser accesses the disclosed system from a client computer device, which is typically located remote from the server device that actually implements the insurance product marketplace. In one embodiment, upon accessing the marketplace, the server computer causes a plurality of questions to be posed to the purchaser. In this embodiment, the questions are designed to ascertain details about the type of insurance coverage the individual is seeking, as well as preliminary questions about the type of risk associated with the individual.

In one embodiment, upon receiving answers to the questions, the server device of the disclosed system mines all the transaction information available in the marketplace, such as historical customer purchase decisions, carrier offers, and previous insurance policies sold through the system. According to the results of this data mining process, in one embodiment the system displays a series of quasi-quotes for insurance coverage and related purchase information based on the answers to the questions. In one embodiment, these quasi-quotes are preliminary, and are provided to give the customer an idea of the potential coverage available to him or her through the disclosed marketplace system. As discussed above, this capability to quickly see a snapshot of the universe of coverage options available to the individual is advantageous over known systems, in which comparing options for insurance was cumbersome and time-intensive.

In one embodiment, after displaying the initial set of potential insurance options to the customer, the disclosed system requests that the customer fill out a single, universal application for insurance. This initial application may be submitted directly by the consumer (e.g., using a web browser to access a web server with an appropriate input mechanism) or through an agent (e.g., via a telephone call with an agent of the insurer). In one embodiment, this initial application constitutes an authorization to receive offers for insurance.

In one embodiment, prior to the individual filling out the single application, the disclosed system has already received an indication from each of the plurality of insurance providers utilizing the system that the information on the single application is sufficient for those providers to underwrite the risk associated with the individual seeking insurance. Thus, in one embodiment, the single application is pre-ordained to be sufficient to enable the customer to apply for coverage to the plurality of available insurance providers. In various embodiments, the disclosed marketplace system includes a mechanism for the customer to sign the application. Thus, the disclosed system advantageously enables the individual to apply for insurance from a plurality of different providers by using a single, standardized application predetermined to be acceptable to each provider. In one embodiment, signing the application constitutes authorization for the marketplace system to solicit offers for insurance on behalf of the individual.

In one embodiment, after the customer submits the signed single application for insurance, the system facilitates the plurality of insurers underwriting the risk associated with insuring the individual. For example, the system in one embodiment orders appropriate records from publicly available databases and performs initial underwriting based on the obtained data. In this embodiment, the disclosed system provides each of the plurality of insurers with an indication of the outcome of the underwriting, such as by providing a quantification of the risk associated with the individual along a standardized scale or range of risk. In one embodiment, since the single application has been vetted by the plurality of insurance providers, the underwriting performed based on the application and other evidence is also acceptable to the plurality of insurers. Thus, in one embodiment, the disclosed system advantageously enables a single underwriting analysis to be used by each of a plurality of insurance providers.

In one embodiment, based on the initial underwriting performed using the filled-out common application, the disclosed system provides the customer with an option for immediate short-term insurance coverage while the risk is more fully underwritten. For example, if the customer is seeking $500,000.00 in all-cause life insurance, the system may display an option for one year of all-cause life insurance in the amount of $500,000.00 based on the initial underwriting, such that the individual can have the desired coverage while the risk is more fully underwritten and a longer-term option is determined. In this way, the disclosed system addresses the concern of known systems that the individual seeking insurance frequently cannot receive the desired coverage immediately upon applying for insurance.

In one embodiment, in response to the request for coverage and submission of information, an insurer issues insurance coverage (e.g., a policy) with a relatively short term that takes effect immediately or substantially immediately. In one embodiment, the insurer does not require the individual to undergo a medical examination, and does not perform substantial underwriting of the risk associated with the immediate insurance coverage. In one embodiment, the coverage is provided upon the potentially insured individual submitting a first premium amount and the requisite information about himself or herself. In an embodiment, the relatively short-term coverage is non-renewable, and provides the insured individual with coverage while longer-term coverage is underwritten and offered to the individual.

In parallel with making the offer to the individual for short-term coverage (if applicable), the disclosed marketplace system in various embodiments forwards the information about the individual to a marketplace underwriter component of the system. In one embodiment, the marketplace underwriter performs a comprehensive underwriting process on the risk presented by the customer of insurance. For example, the marketplace underwriter component may analyze online health records of the user and/or the results of a previous medical examination to which the user has submitted. The marketplace underwriter in various embodiments provides an assessment of the risk presented by the customer to a plurality of carriers, who can then decide whether to offer the customer the desired long-term coverage.

In one embodiment, if a carrier decides to offer the desired long-term coverage, the customer is given the option to accept the offer, and the long-term coverage replaces the existing short-term coverage some time before the end of the short-term coverage. Thus, in one embodiment, the disclosed system advantageously enables a user to apply for insurance coverage and to receive the applied for coverage immediately, while receiving the desired coverage in the long term by long-term coverage that replaces the short-term coverage. This embodiment addresses the shortcoming of known systems, discussed above, that seekers of insurance frequently wish to receive immediately upon applying for coverage.

In various embodiments, this long-term or additional coverage is provided by an insurance company or other insurer different from the provider of the initial coverage. For example, in one embodiment the system disclosed herein enables a potential customer to provide information about himself or herself and have that information made available to a plurality of insurance companies, any one of which may make an offer of insurance coverage. Thus, the disclosed system advantageously enables an individual to receive offers of insurance from any one of a plurality of different insurers without having to directly contact each of the plurality of insurers.

In various embodiments, the disclosed system further enables the problems discussed above to be addressed by providing purchasers of insurance with the potential to receive the desired long-term coverage immediately upon applying for insurance. In one such embodiment, since a single application exists for a plurality of carriers, the carriers may be able to define a set of circumstances in which coverage is to be immediately offered, such as if an individual is very healthy and falls in a certain age range. In this embodiment, upon the individual applying for insurance, the disclosed system presents one or more offers for immediate, long-term coverage to the individual. Thus, in this embodiment, the need to rely on the initial short-term coverage, which is eventually replaced by long-term coverage, may be avoided for certain customers. It should be appreciated that the use of a standard application, predetermined to be acceptable to one or more carriers, advantageously enables this immediate issuance of long-term insurance coverage.

As discussed above, another workflow enabled by the disclosed system can be viewed from the perspective of the carriers of insurance as opposed to the customers of insurance. This workflow, which is described in more detail below, advantageously enables customers who have entered the disclosed system with an affiliation with a certain carrier to be inserted into the marketplace as a whole in the event the initial carrier cannot satisfy the customer's needs.

In one embodiment, each carrier wishing to participate in the disclosed marketplace sets up a series of filters that define those customers who are most likely to receive a good offer for coverage from the carrier. In one embodiment, the disclosed system displays an interface to the carriers to enable the creation of such filters. In further embodiments, these filters also define one or more other carriers with which the carrier has a “carrier to carrier relationship,”

In one embodiment, a customer enters the disclosed marketplace with an affiliation with a particular carrier. For example, if an individual customer enters the disclosed marketplace using a link from a carrier's website, the customer enters with an affiliation with that carrier. In one embodiment, at various points during the application process for insurance, if an individual does not satisfy the carrier's defined filters, the disclosed system moves the customer out of the carrier-specific path and into the general marketplace. In other words, in various embodiments, the disclosed system is configured to remove or disassociate a customer's affiliation with a particular carrier. In one such embodiment, if an individual indicates that he or she wishes to purchase coverage that the carrier's filter indicates is not provided by the carrier, the disclosed system may move the individual into the main flow of the marketplace as a whole.

In various embodiments, the disclosed system provides a plurality of decision points to determine whether the individual matches an appropriate carrier filter. For example, the disclosed system in one embodiment determines whether the individual fits a carrier profile at the time the customer enters the disclosed system (e.g., at the time of linking from the carrier's website), at the time of answering the initial questions discussed above, at the time of filling out the single application for insurance, and after underwriting. If, at any of these points in time, the customer does not satisfy the carrier profile, the disclosed system moves the customer into the general marketplace, and the workflow described above with respect to the customer is resumed with the full universe of carriers available to the customer.

In various embodiments, the carrier profile functionality discussed above is transparent to the customer. That is, in various embodiments, the customer is unaware that he or she initially enters the system with a particular affiliation with a carrier, and is subsequently unaware if the carrier profile filter of that carrier indicates that the customer is no longer a good match with that carrier. Thus, the disclosed workflow from the perspective of the carriers is not discernable to the customers.

It should be appreciated that with regard to the carrier workflow embodiment described above, the disclosed system advantageously enables customers to be retained by a particular carrier responsible for bringing the customer to the system unless and until the customer is determined not to be a good match for the carrier. Thus, the embodiment described above addresses some of the shortfalls of known systems with regard to customer affiliations with certain carriers.

In some prior situations, life insurance sales systems themselves attempt to determine which carrier is believed to be a best fit for an applicant. These systems can try to make such determinations based on historical analysis. In these systems, data about the individual is sent directly to the insurance carrier determined to be a best fit, and if possible a transaction is completed. Frequently, in such known systems, no sale of insurance is achieved. It should he appreciated that various embodiments of the disclosed system drastically improve this situation by gathering evidence and performing underwriting of a case without regard to a determined best carrier. Rather than try to discern a best fit carrier, the disclosed system in one embodiment provides risk assessment and evidence to a plurality of carriers, and enables the carriers to determine how the individual fits into their product risk categories. In this embodiment, if the individual represents a risk a carrier is interested in taking on, the system enables the carrier to make an offer to the individual, who is then free to accept the offer. Thus, while prior systems attempt to select a particular carrier for an individual, the disclosed system provides information needed to underwrite the risk associated with the individual to each of a plurality of carriers, and enables the carriers to easily decide which (if any) products to offer to the individual.

Additional features and advantages are described in, and will be apparent from, the following Detailed Description and the figures.

### BRIEF DESCRIPTION OF THE FIGURES

FIG. 1 is a block diagram illustrating an example of the electrical systems of a host device usable to implement the insurance product information marketplace system disclosed herein

FIG. 2 is a flow chart of an example process for progressing through the marketplace system disclosed herein, viewed from the perspective of an individual purchasing insurance coverage.

FIG. 3A is a portion of a flow chart of an example process for progressing through the marketplace system disclosed herein, viewed from the perspective of an insurance provider.

FIG. 3B is a portion of a flow chart of an example process for progressing through the marketplace system disclosed herein, viewed from the perspective of an insurance provider.

### DETAILED DESCRIPTION

The disclosed system implements an insurance marketplace (sometimes referred to as an insurance exchange) for connecting purchasers of insurance products with sellers of insurance products. In one embodiment, the system disclosed herein is implemented in one or more host or server devices, and is configured to interact with a plurality of remote devices. The remote devices in various embodiments can include insurance purchaser devices, insurance agent devices, and/or insurance carrier devices. In various embodiments, the system enables an individual wishing to purchase insurance (or to purchase insurance on behalf of another person) to provide a limited set of information to the system. In response to the limited information, the system intelligently determines a universe of potential insurance product options, from a universe of potential insurance carriers or providers, which may be available to the individual. Thus, the system disclosed herein provides an individual with an easy way to quickly compare potential insurance opportunities available from a plurality of potential insurance carriers, based on the individual's particular characteristics.

If the individual is interested in the displayed options, the system enables the individual to submit a single application for insurance that has been previously approved by the plurality of carriers as containing sufficient information to underwrite the risk associated with insuring the individual. Based on this information (as well as other information obtained from publicly available databases), the disclosed system preliminarily underwrites the risk of insuring the individual. In appropriate embodiments, the system displays an offer for immediate, short-term insurance coverage, which the individual can accept and receive insurance coverage immediately. Thus, the disclosed system advantageously enables an individual to obtain at least some coverage, for at least a short period of time, immediately upon providing information to the disclosed system.

Following the determination of whether to provide immediate insurance, an underwriting module of the disclosed system performs more comprehensive underwriting of the risk of insuring the individual, and generates a risk assessment. The system provides the risk assessment to each of a plurality of carriers, and facilitates the carriers making offers to the individual. If the individual accepts one of the offers for insurance coverage, the system in one embodiment facilitates the payment of an initial premium amount, and the insurance provider replaces the short-term coverage, if any, with the longer-term coverage.

In one embodiment, the system disclosed herein also enables a carrier to define a plurality of criteria for a carrier profile filter applicable to individuals who enter the disclosed system affiliated with the carrier. At various points in the process described above, the system compares the carrier profile filter to the information about particular individuals affiliated with the carrier. At these points in time, if the individual ceases to satisfy the carrier profile, the affiliation between the individual and a particular insurance carrier is removed, and the individual is inserted in the main flow of the marketplace. That is, the individual is provided access to each of the carriers participating in the marketplace, and each of the carriers is provided with access to the individual. It should be appreciated that in this embodiment, the system facilitates an individual being affiliated with a particular carrier or provider, so long as the individual continues to satisfy criteria the carrier or provider views as desirable.

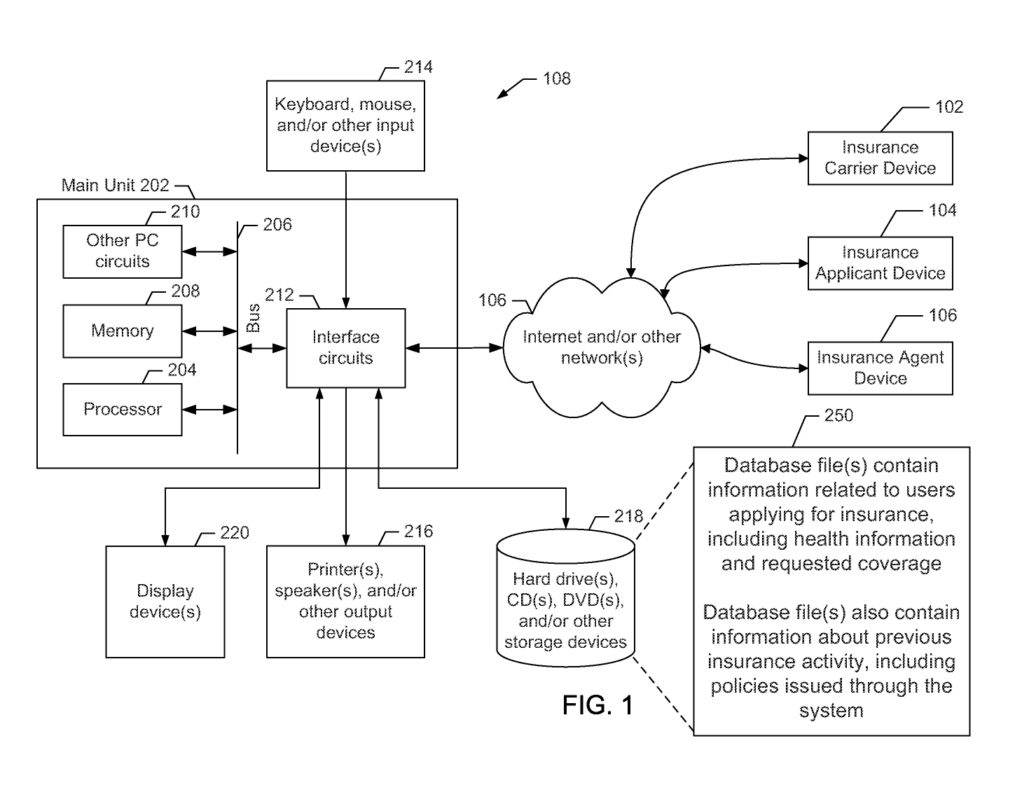

FIG. 1 is a block diagram illustrating an example of the electrical systems of a host device (e.g., host device 108) usable to implement the insurance product information marketplace system disclosed herein. In one embodiment, the host device 108 illustrated in FIG. 1 corresponds to an insurance marketplace host device to connect purchasers of insurance to carriers of insurance, and whose detailed functions and capabilities will be discussed below. In this embodiment, the purchasers of insurance interact with the host device 108 using insurance agent device 106 and/or insurance applicant device 104. In this embodiment, the insurance carriers interact with the host device 108 using insurance carrier device 102.

In the example architecture illustrated in FIG. 1, the host device 108 includes a main unit 202 which preferably includes one or more processors 204 electrically coupled by an address/data bus 206 to one or more memory devices 208, other computer circuitry 210, and/or one or more interface circuits 212. The one or more processors 204 may be any suitable processor, such as a microprocessor from the INTEL PENTIUM® family of microprocessors. PENTIUM® is a trademark registered to Intel Corporation and refers to commercially available microprocessors.

In one embodiment, host device 108 includes memory 208. Memory 208 preferably includes volatile memory and non-volatile memory. Preferably, the memory 208 stores one or more software programs that interact with the hardware of the host device 108 and with the other devices in the system as described below. In addition or alternatively, the programs stored in memory 208 may interact with one or more insurance carrier devices, such as device 102, to enable insurance carriers to interact with the insurance marketplace system described herein. Likewise, the programs stored in memory 208 may interact with one or more insurance applicant devices, such as device 104, or one or more insurance agent devices, such as device 106, to enable individuals to purchase insurance, either for themselves or on behalf of other individuals, using the disclosed system.

The programs stored in memory 208 may be executed by the processor 204 in any suitable manner. The memory 208 may also store digital data indicative of intangible information, such as information about an individual applying for insurance coverage, information about insurance coverage available from carriers affiliated with the marketplace system, files, programs, web pages, etc. received from insurance carrier device 102, insurance applicant device 104, insurance agent device 106, or some other appropriate source.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system. In one embodiment, wherein the host device 108 is designed to be operated or interacted with only via remote devices, the host device 108 does not include input devices 214.

One or more displays 220, printers, speakers, and/or other output devices 216 may also be connected to the main unit 202 via the interface circuit 212. The display 220 may be a cathode ray tube (CRT), liquid crystal display (LCD), or any other type of display. The display 220 generates visual representations of data during operation of the host device 108. For example, the display 220 may be used to display a representation of at least a portion of one or more pieces of information, such as one or more pieces of data about a potential insured or about a product offering by an insurance carrier. Alternatively or in addition, the display 220 may be utilized to display reporting or other statistical information about the sales activity facilitated by host device 108. In one embodiment, the host device 108 does not include a display, and access to the host device 108 is performed substantially entirely through insurance carrier device 106, insurance applicant device 104, and/or insurance agent device 102.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the host device 108. In one example described in more detail below, the storage device 218 stores database information 250 including web site data, data needed to cause the marketplace to operate, information about applicants for insurance, information about products offered by insurance carriers, information indicative of carrier trigger criteria, and/or other information required to facilitate the sale and purchase of insurance by users and carriers at the various devices 102, 104, and 106. Further, the storage device 218 may also include database 250 that includes data needed to facilitate the online marketplace disclosed herein, such as web site information, purchasing software including software to enable a user to complete an application or provide an indication of an acceptance of an offer and the like.

In one embodiment, the host device 108 exchanges data with the insurance carrier device 102, the insurance applicant device 104, and/or the insurance agent device 106 to implement an efficient insurance marketplace. In a further embodiment, the disclosed system enables a plurality of each kind of device to communicate with one another. For example, the system enables a plurality of insurance carrier devices 102 to communicate with a plurality of insurance applicant devices 104 and/or a plurality of insurance agent devices 106. In a further embodiment, these devices can communicate with the host device 108 such that information can be exchanged by and between users at each of those devices. For example, as discussed in detail below, the host device 108 may enable a user at a remote insurance applicant device 104 to provide information relating to an application for insurance, which information may eventually be received by a remote insurance carrier device 102. In some embodiments, as discussed below, the host device 108 acts as a central repository, such that the remote applicant for insurance and the remote carrier device each communicate information to the host device 108. In this embodiment, the host device 108 facilitates the insurance marketplace using the information provided by the plurality of remote devices, such as by matching insurance applicants with carriers offering a desired type of insurance product.

Preferably, this connection of devices (i.e., the host device 108, the remote insurance carrier device 102, the remote insurance applicant device 104, and the remote insurance agent device 106) is facilitated by a network connection over the Internet and/or other networks, illustrated in FIG. 1 by cloud 106. The network connection may be any suitable network connection, such as an Ethernet connection, a digital subscriber line (DSL), a WiFi connection, a cellular data network connection, a telephone line-based connection, a connection over coaxial cable, or another suitable network connection.

Access to host device 108, remote insurance carrier device 102, remote insurance applicant device 104, and/or remote insurance agent device 106 may be controlled by appropriate security software or security measures. An individual user's access can be defined by the host device 108 and limited to certain data and/or actions. Accordingly, users of the system may be required to register with one or more remote insurance carrier devices 102, remote insurance applicant devices 104, and/or remote insurance agent devices 106 prior to attempting to purchase or attempting to sell insurance in the insurance marketplace facilitated by the disclosed system.

In a preferred embodiment, each of the remote insurance carrier device 102, remote insurance applicant device 104, and/or remote insurance agent device 106 has a similar structural or architectural makeup to that described above with respect to the host device 108. That is, each remote device in on embodiment includes a display device, at least one input device, at least one memory device, at least one storage device, at least one processor, and at least one network interface device. It should be appreciated that by including such components, which are common to well-known desktop, laptop, or mobile computer systems (including smart phones, tablet computers, and the like), remote insurance carrier device 102, remote insurance applicant device 104, and/or remote insurance agent device 106 facilitate interaction among and between each other by users of the respective systems.

In various embodiments, devices 102, 104, 106, and/or 108 as illustrated in FIG. 1 may in fact be implemented as a plurality of different devices. For example, the host device 108 may in actuality be implemented as a plurality of server device operating together to implement the insurance marketplace system described herein. Moreover, in one embodiment, at least one of the devices 102, 104, and 106 may be accessible to a user using a telephone or other device remote from devices 102, 104, 106, and 108. In this embodiment, an applicant for insurance may use a conventional telephone to access a voice-based system enabling the applicant to provide information about a desired insurance product and/or about himself or herself. In this embodiment, at least one remote insurance applicant device 104 receives the information entered via telephone and forwards the information to host device 108 for processing or other handling. In other words, in various embodiments, one or more users accesses insurance carrier device 102, insurance applicant device 104, or insurance agent device 106 using another, un-illustrated device.

In various embodiments, one or more additional devices, not shown in FIG. 1, interacts with the host device 108 to facilitate the purchase of insurance. For example, in one embodiment the host device 108 communicates via network 106 with one or more public repositories of information, such as a motor vehicle records database or a public health records database. As will be described below, in this embodiment, the host device 108 retrieves information pertaining to an individual seeking insurance, such that the relationship between the individual and a potential insurance carrier can be more efficiently facilitated. In another embodiment, the host device 108 communicates via network 106 with one or more financial institution devices, such as one or more bank devices, to facilitate the individual providing premium payments for a purchased insurance product. In other embodiments, the host device 108 communicates with appropriate remote devices needed to perform other functions in the process of selling insurance products to individuals.

In various embodiments of the system disclosed herein, multiple different kinds of users can interact with the host device 108 to access the disclosed insurance marketplace system. For example, one embodiment the system enables a purchaser of insurance (or an agent acting on behalf of a purchaser) to interact with the host device 108, which implements the disclosed insurance marketplace, to explore options for and ultimately purchase insurance. In another embodiment, the system enables a representative of an insurance carrier to interact with the host device 108, which implements the disclosed insurance marketplace, to solicit the purchase of insurance by members of the marketplace.

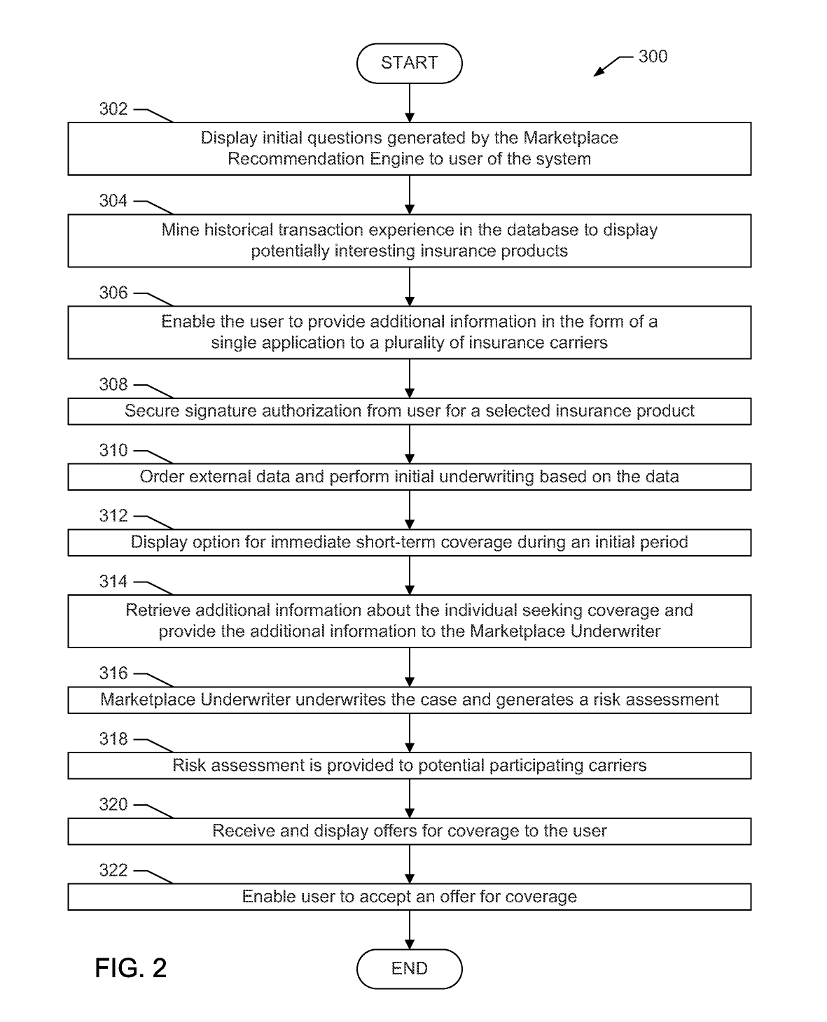

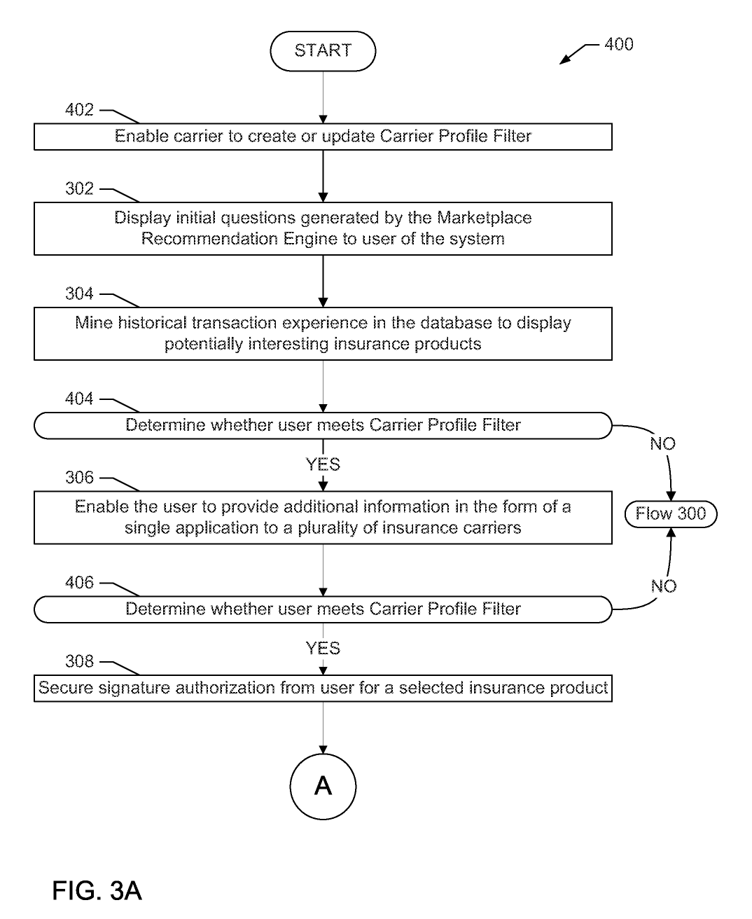

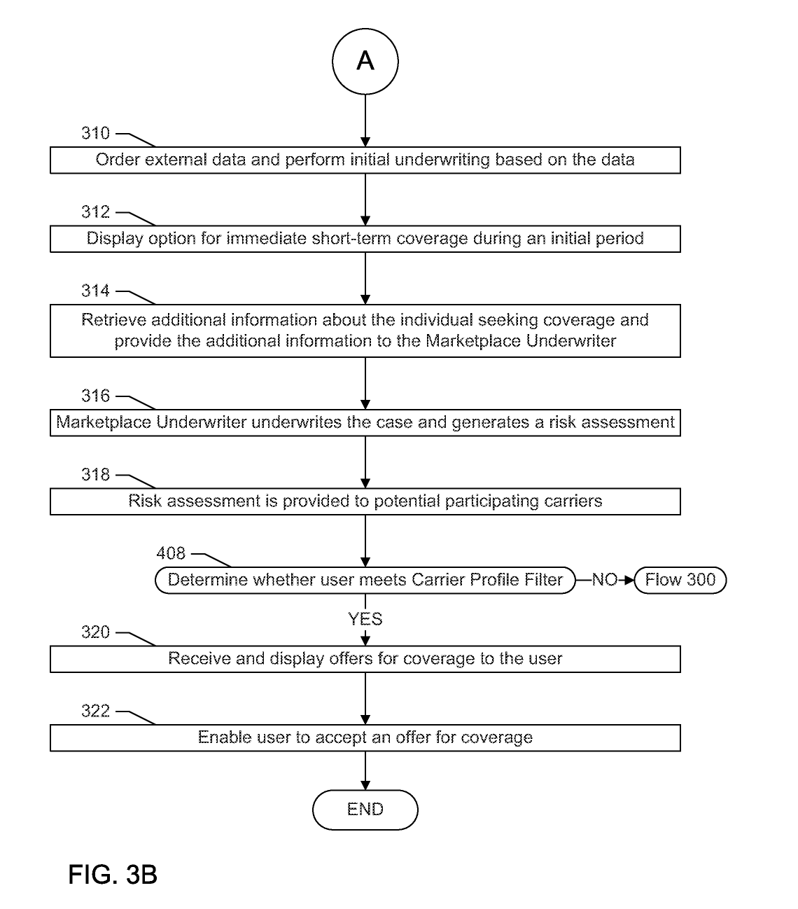

An exemplary flow chart describing one embodiment of an interaction by an individual seeking to purchase insurance with the disclosed system is illustrated at FIG. 2. An exemplary flow chart describing one embodiment of an interaction by an insurance carrier seeking to sell insurance with the disclosed system is illustrated at FIGS. 3A and 3B. As will be described below, many of the steps in the processes illustrated in FIGS. 2 and 3A and 3B overlap, and apply to both processes.

Referring first to FIG. 2, a flow diagram 300 of an exemplary process flow from the perspective of a potential purchaser of insurance is illustrated. The process flow illustrated by the flow diagram 300 is facilitated in one embodiment by the insurance marketplace system disclosed herein. In the embodiment illustrated in FIG. 2, the various process flow operations are facilitated or performed by the host device 108, which is operatively connected with insurance carrier device 102, insurance applicant device 104, and/or insurance agent device 106. R should be appreciated that the flow diagram 300 of FIG. 2 is an exemplary flow. In other embodiments, additional or different steps are possible consistent with the remainder of the instant disclosure. It should be appreciated that in the following description, the term “user” is variously used to refer to either purchaser of insurance, either for the user as the insured individual or on behalf of an insured individual.

In the embodiment of the exemplary flow 300 illustrated in FIG. 2, process starts with the disclosed system presenting one or more questions to a user of the system, as illustrated in block 302. In this embodiment, the questions are generated by a component of the system called the Marketplace Recommendation Engine. The Marketplace Recommendation Engine in this embodiment is a software component responsible for receiving information from the user and for filtering information contained in the marketplace system based on the received information, as will be described in more detail below. In various embodiments, the questions from the Marketplace Recommendation Engine are designed to assess the life situation of a potential purchaser of insurance, such as questions about the type of insurance product desired, the family structure of the potential purchaser, and the like. In a further embodiment, the system generates the questions based on stored data about past insurance purchases to try to minimize the amount of data needed from the user to maximize the narrowing of potential insurance options for the individual.

In one embodiment, the questions are a fixed set of questions answerable by all potential purchasers of insurance. In another embodiment, the questions are dynamic, such that a particular answer to a question results in a follow-up question being asked or not being asked, as appropriate. In various embodiments, the host device 108 executes the software instructions implementing the Marketplace Recommendation Engine to cause textual representations of the questions to be displayed on a website. In other embodiments, the disclosed system asks the user questions by providing voice prompts generated by an automated system, or displays the questions to an agent, who asks the questions to the potential purchaser in person or by telephone.

After displaying or otherwise asking the questions discussed above, the Marketplace Recommendation Engine of the illustrated embodiment mines the transactional experience of the disclosed marketplace system, based on the user's answers to the questions, to display a plurality of potentially interesting insurance products. This step is illustrated in block 304. In one embodiment, based on past data relating to the purchase of insurance, the disclosed host device 108 determines other situations in which an individual in a similar life situation wished to purchase a similar kind of insurance product.

In one embodiment, the system displays an aggregation or summary of the products purchased in similar situations, which preferably represents potentially interesting products. In various embodiments, the disclosed host device 108 searches the database 250 on storage device 118 based on information provided by the potential purchaser to ascertain historical purchaser decisions, carrier offers, and other similar data to make recommendations about potentially interesting products.

In one embodiment, if the user or purchaser of insurance is interested in purchasing one of the insurance products displayed by the host device 108, the system enables the person to provide additional information about himself or herself, as illustrated by block 306. Specifically, as illustrated in block 306, the system enables the individual to complete a single application for insurance, thereby streamlining the application process. In one embodiment, the single application for insurance has been vetted and accepted by each of the plurality of carriers participating in the disclosed marketplace. By vetting and accepting the application, the carriers in one embodiment indicate that the information solicited by the application is sufficient for each provider to fully underwrite the risk associated with an individual. Thus, by facilitating the potential purchaser completing the single application, the system provides each of the relevant carriers enough information to underwrite the risk, or to be satisfied that risk underwritten using the information is adequately underwritten.

With regard to block 308, the system secures a signature authorization from the applicant for a selected insurance product. In various embodiments, the system secures signature authorization using a voice signature, a click-stream signature method, or some other signature method appropriate in an online purchasing context. In one embodiment, this signature authorization represents an acceptance, by the user, of an offer by a carrier to provide insurance.

In other words, in one embodiment, the user selects a particular one of the potential insurance products generated by the disclosed marketplace system, as discussed above. As discussed below, this selection can be considered a request by the user for an offer from the carrier. Upon selecting the product, the system presents a signature form to the user, which in one embodiments constitutes an offer from the carrier of that product to sell the product to the potential purchaser. Completing the signature form, in one embodiment, constitutes the purchaser accepting the insurance carrier's offer of insurance.

In one embodiment, following the acceptance of the offer by the user providing a signature, the system orders external data and performs initial underwriting based on the initial data, as illustrated in block 310. As will be appreciated by a person of ordinary skill in the art, this external information could include motor vehicle records (MVR) data, medical information bureau (MIB) data, prescription and/or pharmaceutical data, electronic health records (EHR), and other suitable underwriting data

Based on the underwriting performed on this initial data, the system in one embodiment provides an offer for immediate short-term coverage for an initial coverage period, as illustrated in block 312. In this embodiment, if the information solicited to perform the initial underwriting indicates that an individual would be a good insurance risk, the disclosed system indicates that the user is eligible to receive immediate coverage. The system enables the user to accept the offer of short-term coverage, which advantageously enables the individual to receive at least some coverage substantially immediately upon accessing the marketplace system. In one embodiment, the short-term policy lasts for one year, and is designed to bridge the gap between the application for insurance and the implementation of the longer-term insurance policy. In various embodiments, if the user does not qualify for the short-term insurance, the disclosed marketplace system does not perform block 312, instead proceeding directly to block 314 below.

Regardless of whether immediate insurance was available to the user, the disclosed system proceeds by retrieving additional information about the individual and providing that information to the Marketplace Underwriter, as indicated by block 314. In one embodiment, the Marketplace Underwriter is a software module executed by the host device 108 to determine the risk associated with an individual. In one embodiment, the additional information could determine that an attending physician statement, or APS, is required to fully underwrite the risk presented by the individual. After retrieving the necessary information, the Marketplace Underwriter underwrites the case and generates a risk assessment associated with the individual seeking insurance, as indicated by block 316. As noted above, the presence of the single application, which the carriers participating in the disclosed system have confirmed contains sufficient risk analysis information, enables the Marketplace Underwriter to perform an underwriting task that is acceptable to each of the carriers involved in the system.

Upon the generation of the risk assessment by the Marketplace Underwriter, the disclosed system in one embodiment makes the risk assessment information available to potential insurance carriers participating in the disclosed marketplace, as indicated by block 318. In one embodiment, the underwriting information is provided to each carrier participating in the disclosed system. In one embodiment, each carrier provides a series of criteria that define whether the carrier might be interested in the risk determined by the Marketplace Underwriter. In another embodiment, the system determines which carriers might be interested based on historical data about insurance products previously sold by each carrier.

Next, the disclosed system waits for carriers to make offers for long-term insurance based on the underwriting information. If the system receives any offers provided by one or more carriers, the system causes the display of one or more of the offers to the individual seeking insurance, as indicated by block 320. In one embodiment, the offers received from the carriers constitute offers for additional coverage, beyond the initial coverage provided prior to comprehensive underwriting. In another embodiment, wherein an individual was not offered (or did not accept offers for) initial, short-term coverage, the offers displayed at block 320 constitute a first set of offers for insurance coverage.

In one embodiment, beyond simply displaying the offers for coverage, the system disclosed herein also performs some measure of evaluation of the offers. For example, the disclosed system in one embodiment compares the received offers with the initial information provided by the user to determine whether the offers for insurance correspond to the coverage initially sought.

In one embodiment, the system enables the user to accept one or more offers for coverage, as indicated by block 322. In various embodiments, this acceptance can be communicated by selecting a check-box, providing another digital signal, or otherwise indicating to the host device 108 that the individual wishes to accept an offer for insurance. In this embodiment, regardless of the user's action with respect to the offers for coverage, the system stores an indication of the action such that the user's activities can augment the data stored by the system. This storage advantageously enables the system to make more informed suggestions based on the more complete set of data available to it.

In an embodiment, upon accepting the additional coverage offer, the disclosed system informs the carrier, and the carrier begins providing the purchased coverage. In a further embodiment, the system facilitates the payment of a first premium payment. In this embodiment, the coverage provided by the carrier is predicated on the receipt of this payment. Thus, the system may play an important role in the transaction between the individual and the carrier directly.

In one embodiment, the system disclosed herein advantageously maintains a comprehensive account profile for each user of the system. In this embodiment, each time a customer logs in to the disclosed system, previous data about the individual (including previously-collected underwriting information) is stored for retrieval, such that the individual does not need to re-enter (and the system does not need to re-ascertain) much of the pertinent information. In this embodiment, the system thus renders the process of returning to purchase additional insurance substantially easier than in known systems. In one embodiment, if a user purchases temporary or short-term coverage on a first visit, and later returns to purchase longer-term coverage, the user will find that the system has stored the majority of the information pertaining to the user.

In one embodiment, the system disclosed herein provides short-term coverage only in situations in which longer-term insurance cannot be immediate provided. For example, if the disclosed system has access to EHR data for a particular individual, the system may be able to fully underwrite the risk presented by the individual substantially immediately, and thus may be able to provide longer-term coverage at the time of acceptance of the carrier's offer. In various embodiments, this is especially likely to be possible in situations where a great deal of data (e.g., EHR records) is available about an individual or where the accepted offer is for an insurance product with a lower face amount.

In one embodiment, the disclosed system also includes a software component called the Marketplace Product Performance Analyzer. This software component, like the other software components discussed above, includes a plurality of software instructions stored in memory of the host device 108 and executed by a processor in the host device 108. In one embodiment, the Marketplace Product Performance Analyzer provides product and service providers, such as carriers, reinsurers, paramedical companies, prescription profile firms, and other providers, with information about insurance products sold through the disclosed system. In various embodiments, this information is easily sortable such that the product and service providers CaO easily make use of the information to drive improvements in their products while also discovering and serving niche markets.

It should be appreciated that for many of the software components described herein, such as the Marketplace Recommendation Engine and the Marketplace Underwriter, the accuracy and efficiency of the system increases as the data available in the system grows. For example, as additional insurance transactions are performed using the disclosed system, the disclosed system becomes better able to predict what kinds of products will interest particular purchasers of insurance.

In one embodiment, in which temporary insurance and permanent insurance are both purchased by a single user, it should be appreciated that two offer/acceptance processes have occurred. For each offer/acceptance pair, the application for insurance in one embodiment constitutes an invitation for an offer from an insurance provider. In response, the insurance provider provides an offer of insurance, and the user can accept the offer by signing or otherwise communicating acceptance. In this way, the application for insurance can be viewed as a perpetual application for insurance (i.e., a perpetual solicitation for offers) for as long as the user's authorization to pull data about the person exists. Thus, the application can also be viewed as a consumer profile with an authorization to solicit offers and retrieve data about the consumer.

Referring now to FIGS. 3A and 3B, a flow diagram 400 of an exemplary process flow from the perspective of an insurance carrier or other provider is illustrated. In the illustrated embodiment, it should be appreciated that the flow diagram 400 begins in FIG. 3A and is continued, as indicated by the “A” indicator, in FIG. 3B.

The process flow illustrated by the flow diagram 400 is facilitated in one embodiment by the insurance marketplace system disclosed herein. In the embodiment illustrated in FIGS. 3A and 3B, the various process flow operations are facilitated by the host device 108, which is operatively connected with insurance carrier device 102, insurance applicant device 104, and/or insurance agent device 106. It should be appreciated that the flow diagram 400 of Figs, 3A and 3B is an exemplary flow. In other embodiments, additional or different steps are possible consistent with the remainder of the instant disclosure.

In one embodiment, one or more of a plurality of insurance carriers participating in the disclosed marketplace are required to execute a Carrier Marketplace agreement. In this embodiment, in addition to executing the Carrier Marketplace agreement, the disclosed system enables the carriers to set up and continuously refine and/or enhance a Carrier Profile Filter associated with that carrier. In various embodiments, the carrier alters the Carrier Profile Filter using one or more insurance carrier devices, such as insurance carrier device 102 connected to host device 108. In these embodiments, the Carrier Profile Filter is stored in memory of the host device 108.

In various embodiments, the Carrier Profile Filter helps to identify customers likely to receive a good offer from a particular carrier. In other embodiments, the Carrier Profile Filter helps to identify customers likely to receive a good offer from a list of carriers who have a carrier-to-carrier relationship with a particular carrier. In these embodiments, carriers with a carrier-to-carrier relationship may be viewed as preferred carriers. As will be discussed below with regard to FIG. 3, individuals who enter the disclosed marketplace affiliated with a carrier but fail to meet the criteria defined in the carrier's Carrier Profile Filter are passed into the marketplace path defined above with respect to FIG. 2. That is, if a user enters the marketplace with a particular carrier affiliation, the Carrier Profile Filter can define criteria that cause the user to be inserted into the marketplace without the affiliation.

Against the above backdrop, the flow chart 400 illustrated in FIGS. 3A and 3B will be described. In the illustrated embodiment, at block 302, the disclosed system enables the carrier to input a new Carrier Profile Filter, or to update an existing Carrier Profile Filter, as discussed above. Next, as was described above with respect block 302 of FIG. 2, the disclosed system displays initial questions generated by the Marketplace Recommendation Engine to the user of the system. As also described above with respect to block 304, the system mines historical transaction experience to display potentially interesting insurance products to the user. It should be appreciated that from the user's perspective, the steps illustrated by blocks 302 and 304 are the same as in the flow chart 300 of FIG. 2. However, it should also be appreciated that in one embodiment, the data which is mined, and the offers presented, originate only at the carrier with which the user is affiliated and any carriers with carrier-to-carrier relationships with the affiliated carrier.

In the illustrated embodiment, after mining the historical transaction data and displaying potentially interesting insurance products, the process 400 differs from the previously described process 300. At block 404, the system determines whether the user meets the carrier's Carrier Profile Filter based on all the information known to the system at that point in time. If the user does not satisfy the carrier's Carrier Profile Filter, the disclosed system inserts the user into the process 300 described with respect to FIG. 2. In other words, the disclosed system allows the user to continue interacting with the disclosed marketplace system, including reviewing and requesting offers, from each of the plurality of carriers utilizing the system. In this embodiment, the affiliation between the user and any carrier responsible bringing the user to the marketplace is lost. It should be appreciated that the failure of a user to continue to satisfy the Carrier Profile Filter may mean that the user and the carrier are not a good match for one another, for example because the user does not present the type of risk the carrier is interested in undertaking, or because the user is interested in purchasing products not sold by the affiliated carrier.

If, however, the user still satisfies the Carrier Profile Filter at block 404, the user continues to be affiliated with the carrier for purposes of the disclosed system. In such a situation, the system continues by enabling the user to provide additional information in the form of a single application, as illustrated by block 306.

After receiving the single application, the system again determines, at block 406, whether the user satisfies the Carrier Profile Filter. As above, if the user does not satisfy the Carrier Profile Filter, the user is inserted into the marketplace (i.e., process flow 300) without affiliation with a particular carrier. On the other hand, if the user satisfies the Carrier Profile Filter, the user continues to block 308 of FIG. 3, with continued affiliation with the carrier. Specifically, at block 308, the system enables the user to provide a secure signature authorization as described above with respect to FIG. 2. As described above, it should be appreciated that this secure signature may represent a request to receive offers from the affiliated carrier and any carriers with an appropriate relationship to the affiliated carrier.

After block 308, the process continues to block 310, which is illustrated in FIG. 3B, as illustrated by the connection “A” illustrated in both FIGS. 3A and 3B.

In the illustrated embodiment, at block 310, the disclosed system ascertains external data and performs initial underwriting based on that data. Referring still to FIG. 3B, the system displays an option for immediate short-term coverage, if applicable, at block 312. Thereafter, the system retrieves additional information about the individual seeking underwriting, and provides the information to the Marketplace Underwriter for underwriting, as illustrated at blocks 314 and 316. For each of these steps, in the illustrated embodiment, it should be appreciated that the user continues to have an affiliation with the particular carrier, as described above. In other words, the offers displayed to the individual, and the information obtained from the individual, is provided to and from the affiliated carrier, respectively

After the Marketplace Underwriter underwrites the case and provides the risk assessment, as indicated by block 316, the system makes its final determination as to whether the user still satisfies the Carrier Profile Filter, as indicated by block 408. As above, if the user no longer satisfies the Carrier Profile Filter, the user is removed from the flow with a carrier affiliation and inserted into the general marketplace. At this point, the user has the opportunity to purchase insurance coverage from any one of a plurality of carriers, regardless of the carrier's affiliation with the user.

if, however, the user still satisfies the Carrier Profile Filter, the user is presented with offers for coverage from the affiliated carrier, as illustrated in block 320, and the system enables the user to accept the offer for coverage, as illustrated in block 322. If the user accepts the offer for coverage, as with the flow 300 of FIG. 2, the insurance provider whose coverage was accepted replaces any short-term coverage with the accepted long-term coverage. In the embodiment illustrated in FIG. 3B, the insurance provider is the affiliated provider, since the user continued to satisfy the Carrier Profile Filter throughout the process 400.

In summary, from the perspective of a carrier participating in the disclosed marketplace, the system disclosed herein enables the carrier to define a profile filter such that an individual can enter the marketplace affiliated with the carrier, but can have that affiliation removed at various points during the process of providing insurance.

In other embodiments, the disclosed system applies the Carrier Profile filter at different points during the purchase process, such as at each step of the purchase process or after fewer steps than illustrated in FIGS. 3A and 3B.

In one embodiment, an affiliation is established if a particular carrier is responsible for the user entering the disclosed marketplace system. For example, if a user enters the disclosed system by clicking on an advertisement for carrier A's product, the user remains affiliated with carrier A so long as carrier A's profile permits it. Thus, carrier A is provided with a competitive advantage over the other carriers using the system, at least with regard to the user that clicked carrier A's advertisement. Likewise, if carrier A has a carrier-to-carrier relationship with carriers B and C, and vice versa, then carriers A, B, and C have the first chance to provide insurance coverage to an individual brought to the disclosed system by any of carriers A, B, or C. Thus, in various embodiments the ability to fill out a carrier profile incentivizes carriers to direct purchaser traffic to the disclosed system.

It should further be appreciated that if carrier A is responsible for directing a user to the system, and at some point it becomes clear that carrier A cannot satisfy the needs of the user, the user is transparently passed to the general system and is allowed to receive offers from a plurality of other carriers who may be able to satisfy the user's needs. Thus, the system is advantageous to users in that even if a particular carrier directs the user to the system, the user may have the benefit of all the carriers using the marketplace if the directing carrier becomes unable to fulfill the user's needs.

In one embodiment, the disclosed system prevents an insurance provider from knowing who a customer is until the customer accepts an offer from the provider. For example, the provider may know prior to the acceptance of an offer that the individual is a certain age, has certain medical history, and has a certain familial structure. However, until the person accepts the bid, the insurer may not know the identify of the person.

In various embodiments, the short-term insurance policy discussed herein is referred to as a “stub policy,” and is provided to bridge the gap between the application for insurance and the provision of long-term insurance. In this way, the system advantageously enables an individual to receive insurance coverage substantially immediately upon applying for insurance coverage, and to eventually receive the full coverage desired, without enduring a gap in coverage.

In various embodiments, once the individual has provided information to the marketplace disclosed herein the system can automatically make offers to the individual even after the individual has ceased interacting with the system. In one such embodiment, an individual provides information about himself and indicates that he is interested in a particular kind of insurance. In this embodiment, the particular kind of insurance is not available at the time the individual accesses the system. However, some time later, if the desired type of insurance becomes available, the system may provide an individual with an indication that the desired coverage is available. In a further embodiment, the individual submitting an electronic signature authorizes the system to solicit offers for coverage even in the future. In this embodiment, the system also provides the individual with the ability to set parameters regarding when he or she wishes to receive additional offers, such that the offers are not provided in perpetuity.

In further embodiments, if the individual requests but does not receive certain offers for insurance, the disclosed system can actively solicit insurance providers to make offers comporting with the individual's desires. The disclosed marketplace may perform this task by compiling information about the individual and sending it to various candidate carriers. If the candidate carriers wish to make an offer for the requested coverage, the system may facilitate providing the offer to the individual desiring the coverage.

In one embodiment, if a carrier brings an individual to the disclosed marketplace (such that the individual starts out affiliated with the insurer), the disclosed system provides a monetary payment to the insurer if the individual buys coverage from any provider. That is, if carrier A brings a lead to the disclosed marketplace, and the lead buys coverage from carrier B, in one embodiment the disclosed system disburses a payment to carrier A for bringing in the lead. In one embodiment, the fee comes from a general pool of fees collected from carriers to be a part of the marketplace. In another embodiment, the fee is collected directly from carrier B.

In various embodiments, the disclosed system generates and stores vast amounts of data, both about coverage sold to consumers and coverage not sold (but solicited) to consumers. In various embodiments, the disclosed system makes this data available to consumers and/or carriers for purchase. For example, carriers may wish to purchase data to obtain a more accurate sense for the products that are selling well in the market and to determine which of its products are not selling well. Likewise, consumers may wish to purchase access to this information prior to purchasing life insurance to get a sense for what kinds of coverage may be available to them.

It should be appreciated that one of the substantial advantages of the disclosed system results from the use of a single application for insurance coverage. Specifically, since each of the carriers or insurers has agreed that the information collected by the single application is sufficient to enable adequate underwriting of the risk associated with an individual applying for coverage, an individual only needs to fill out one application to request offers from each of the carriers using the disclosed system. Moreover, since the set of information used to underwrite risk is consistent, a single entity (i.e., a software module in the disclosed system) can perform the underwriting and generate a consistent set of risk classifications, usable by each of the carriers to assess risk. This arrangement removes the need for each of a plurality of insurers to whom an individual applies for insurance coverage to underwrite the risk separately. This is particularly advantageous given the relatively high cost of underwriting risk, especially when the cost does not result in a policy being purchased. Using the disclosed system, the cost of underwriting risk for each individual that purchases insurance is only borne once, and is borne evenly by the entire population of insurance providers. Moreover, the wide variety of carriers and risk tolerances makes it much more likely that an individual who gets as far as submitting to underwriting will ultimately purchase some kind of insurance coverage. Thus, the disclosed system substantially improves over the prior art by reducing the transaction costs associated with selling life insurance.

In one embodiment, the disclosed system represents an improvement over known systems because the disclosed system does not attempt to match an individual with a provider based on determined risk. In some known systems, based on this attempted matching, the individual is put in connection with the provider, and must still apply for coverage from that provider specifically. In one embodiment, the disclosed system relies on a common application, and provides the information learned from the application to each of the participating providers. Based on this distinction, the information presented to an individual in one embodiment of the disclosed system constitutes a list of actual insurance providers willing to provide actual coverage. In other words, in this embodiment, the individual is provided with a series of offers, any of which can be accepted. This significant advantage means that there is substantially less uncertainty to the individual throughout the insurance process.

It should be appreciated that the disclosed system addresses many undesirable points about known mechanisms for purchasing insurance. Specifically, one particularly undesirable point about purchasing insurance in known ways is that once a customer selects a carrier to apply for coverage with, even if that selection is made with a contemplated price, customers frequently find that the application process results in coverage options vastly different from the initial estimates. In known systems, customers do not have the ability to port all the work they have invested (e.g., filling out applications, providing evidence, etc.) to other carriers in the hopes of finding the desired coverage. Embodiments of the disclosed system address this concern by enabling a customer to apply with the system, even if he or she has a preferred insurance provider in mind. In one embodiment of the disclosed system, upon receiving a response from the carriers to which the customer has applied, the disclosed system further enables the individual to continue to receive offers for insurance. This arrangement advantageously enables the customer to compare the offers from the preferred carrier against offers from other, non-preferred carriers.

The disclosed system also advantageously presents insurance providers with at least two options for types of participation in the disclosed marketplace. In a first option, as discussed above, the system enables the insurance providers to sell insurance to customers who do not have a desired carrier upon entering the disclosed system. In this embodiment, the consumer submits a single application via the disclosed system, and the carriers participating in the marketplace review the case and make offers as appropriate. The system enables the consumer to select a desired offer from among the presented offers.

Another advantageous workflow involves a consumer entering the marketplace with a particular affiliation with a particular carrier. In an example embodiment, if a customer enters the marketplace by responding to an Internet advertisement for carrier A, the consumer enters the system with an affiliation with carrier A. In this embodiment, the consumer remains affiliated with carrier A until the carrier's profile dictates otherwise, the consumer decides not to purchase insurance from carrier A, or some other condition occurs. In one embodiment, when the consumer ceases to be affiliated with carrier A, an opportunity is presented to the remaining carriers participating in the disclosed marketplace, as a willing consumer is involved in the system and has not found insurance coverage to his or her liking. In one embodiment, the marketplace system presents offers from other carriers to the customer immediately upon the affiliation being lost or broken. In a further embodiment, carrier A is provided with compensation (such as a fee) if the consumer purchases coverage from another carrier through the disclosed marketplace. This presents carrier A with an incentive to have the customer purchase coverage from some carrier, and also helps carrier A recoup some of its marketing costs associated with directing the customer to the disclosed marketplace. In at least this way, a carrier can benefit from an individual entering the marketplace, even if the individual does not purchase coverage from the carrier directly.

It should be appreciated that the system disclosed herein is described primarily as a marketplace for facilitating the sale of life insurance by a plurality of carriers to a plurality of potential customers. However, in various embodiments, the disclosed system implements a marketplace for other kinds of intangible products that involve analyzing risk. For example, the disclosed system can be used as a marketplace for other types of insurance, such as health insurance, disability insurance, or other related products. In other embodiments, the disclosed system can be used to provide a marketplace for financial products, such as annuities, mortgages, loans, or other products that involve the party selling the product analyzing the customer of the product, such as by analyzing the risk presented by a customer of the product. It should be appreciated that in each of these embodiments, the provision of a marketplace to enable carriers to access a plurality of customers, and to enable customers to access a plurality of carriers, constitutes an improvement over known sales mechanisms for such products. In various embodiments, regardless of the type of product sold using the disclosed system, the system provides a risk assessment to each of the sellers, and enables the sellers to categorize the risk as desired and to offer products for sale to customers if desired based on the risk.

In various embodiments, one of the chief benefits of the marketplace disclosed herein is to enable a customer to purchase a plurality of different (but related) types of products based on a single risk profile associated with that customer. That is, the disclosed marketplace in one embodiment enables carriers to submit offers to sell related products, and can assess the risk underlying those products based on a common risk profile created and maintained by the disclosed system.

Specifically, in various embodiments, the system enables individuals wishing to purchase one product to receive offers for different, related products. For example, if an individual wishes to purchase disability insurance, the disclosed system may collect information relating to the health and employment of the individual, assess the risk, and provide an indication of the assessment to a plurality of disability carriers, as described above. However, in a further embodiment, the system provides risk assessment information to one or more carriers who use the risk assessment to offer another product, other than disability insurance, to the customer. In this embodiment, the other product is related to disability insurance, such as life insurance or health insurance, but deviates slightly from the particular product sought by the customer. Thus, in one embodiment the disclosed system advantageously presents a marketplace that enables customers to purchase both the specific product in which they are interested and related products based on a single application. Likewise, the disclosed system in one embodiment advantageously enables carriers to make offers to sell specific products in which customers are interested as well as related products. This aspect also represents an improvement over known systems, which facilitate sales of only a particular, indicated type of product.

The above description of is exemplary of the features of the system disclosed herein. As noted, the disclosed system could be used to sell any type of information to any type of purchaser of information, and is not limited to selling sales leads. Moreover, the functionality of the above-described system is not limited to the functionalities indicated herein. R should be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1. An insurance product marketplace system comprising:
at least one processor;
at least one network interface device;
at least one memory device for storing a plurality of instructions which, when executed by the at least one processor, cause the at least one processor to operate with the at least one network interface device to:
(a) receive at least one common application for insurance from a potential customer, the at least one common application being satisfactory to a plurality of providers of insurance;
(b) determine an amount of risk posed by the potential customer based on the at least one common application for insurance and at least one piece of information received from a publicly-available database;
(c) provide an indication of the risk posed by the potential customer to the plurality of providers of insurance;
(d) enable the plurality of providers of insurance to make an offer to insure the potential customer;
(e) receive an indication of an acceptance of the offer to insure the potential customer on behalf of the potential customer; and
(f) augment a database of sales history based on the at least one common application for insurance and the acceptance of the offer to insure.

2. The system of claim 1, wherein the plurality of instructions cause the at least one processor to cause a display of a plurality of potential insurance products to the potential customer prior to receiving the at least one common application for insurance.

3. The system of claim 2, wherein the plurality instructions cause the at least one processor to determine the plurality of potential insurance products based on the database of sales history.

4. The system of claim 1, wherein the plurality of instructions cause the at least one processor to debit an account of at least one of the plurality of insurers in exchange for determining the amount of risk posed by the potential customer.

5. The system of claim 4, wherein debiting the account includes debiting the account of a single one of the plurality of insurers.

6. The system of claim 5, wherein debiting the account includes debiting the account of an insurer associated with the accepted offer to insure.

7. The system of claim 1, wherein the plurality of instructions cause the at least one processor to cause a display of at least one offer for short-term insurance prior to receiving the at least one common application for insurance.

8. The system of claim 7, wherein the plurality of instructions cause the at least one processor to receive an indication of an acceptance of the at least one offer for short-term insurance prior to receiving the at least one common offer for insurance.

9. The system of claim 8, wherein the plurality of instructions cause the at least one processor to augment the database of sales history based on the indication of the acceptance of the offer for short-term insurance.

10. The system of claim 7, wherein the offer for short-term insurance is an offer for a one-year insurance policy.

11. The system of claim 1, wherein providing the indication of the risk posed by the potential customer to the plurality of providers of insurance includes providing medical information about the potential customer to the plurality of providers of insurance.

12. An insurance product marketplace system comprising:
at least one processor;
at least one network interface device;
at least one memory device for storing a plurality of instructions which_{;}
when executed by the at least one processor, cause the at least one processor to operate with the at least one network interface device to:
(a) receive an indication that a potential customer is affiliated with a plurality of providers of insurance;
(b) receive at least one common application for insurance from a potential customer, the at least one common application being satisfactory to the affiliated plurality of providers of insurance;
(c) determine an amount of risk posed by the potential customer based on the at least one common application for insurance and at least one piece of information received from a publicly-available database;
(d) provide an indication of the risk posed by the potential customer to the affiliated plurality of providers of insurance; and
(e) enable the affiliated plurality of providers of insurance to make an offer to insure the potential customer.

13. The system of claim 12, wherein the plurality of instructions cause the at least one processor to determine prior to at least one of (a), (b), (c), (d)_{;} and (e) whether the potential customer satisfies a profile associated with the affiliated providers of insurance.

14. The system of claim 13, wherein, if the determination is that the potential customer does not satisfy the profile, the plurality of instructions cause the at least one processor to provide the at least one common application for insurance to a plurality of non-affiliated providers of insurance.

15. The system of claim 14, wherein, if the determination is that the potential customer does not satisfy the profile, the plurality of instructions cause the at least one processor to receive an acceptance of an offer to insure the potential customer made by one of the plurality of non-affiliated providers of insurance.

16. An insurance product marketplace system comprising:
at least one processor;
at least one network interface device;
at least one memory device for storing a plurality of instructions which, when executed by the at least one processor, cause the at least one processor to operate with the at least one network interface device to:
(a) receive at least one common application for insurance from a potential customer, the at least one common application being satisfactory to a plurality of providers of insurance;
(b) provide the at least one common application for insurance to the plurality of providers of insurance;
(c) enable the plurality of providers of insurance to make an offer to insure the potential customer based on the at least one received common application for insurance;
(e) receive an indication of an acceptance of the offer to insure the potential customer on behalf of the potential customer; and
(f) provide the indication of the acceptance of the offer to insure the potential customer to one of the plurality of providers of insurance.

17. The system of claim 16, wherein, when executed by the at least one processor, the plurality of instructions cause the at least one processor to operate with the at least one network interface to receive an indication of a payment mechanism from the potential customer.

18. The system of claim 17, wherein, when executed by the at least one processor, the plurality of instructions cause the at least one processor to operate with the at least one network interface to send an indication of payment to one of the plurality of providers of insurance.

19. The system of claim 16, wherein, when executed by the at least one processor, the plurality of instructions cause the at least one processor to operate with the at least one network interface to provide an indication of payment of a fee to at least one provider of insurance affiliated with the potential customer if the potential customer accepts an offer of insurance from at least one non-affiliated provider of insurance.

20. The system of claim 16, wherein, when executed by the at least one processor, the plurality of instructions cause the at least one processor to operate with the at least one network interface to receive an authorization to solicit offers on behalf of the potential customer in association with the at least one common application for insurance.
